(19) United States
(12) Patent Application Publication
(10) Pub. No.: US 2005/0202119 A1
(43) Pub. Date: Sep. 15, 2005

(54) Apparatus for enhancing a chewing gum experience

(76) Inventors: Donald Ullman, Fairfield, CT (US); Harry Moorhouse, Hohokus, NJ (US); Joseph A. Marino, Lebanon, NJ (US); Carmine Capone, Denville, NJ (US)

Correspondence Address: DARBY & DARBY P.C., P. O. BOX 5257, NEW YORK, NY, 10150-5257, US

(21) Appl. No.: 10/798,829

(22) Filed: Mar. 10, 2004

(51) Int. Cl. A23G 3/30

(52) U.S. Cl. 426/5

(57) ABSTRACT

An apparatus for enhancing a chewing gum experience is provided and includes a first container body, a second container body and a gum holding ring having an upstanding member for receiving and holding a piece of chewed gum. The first container body is releasably coupled to a first section of the gum holding ring, with the first container body defining a first compartment. The second container body is releasably coupled to a second section of the gum holding ring, with the second container body defining a second compartment for storing a plurality of candy pieces. The gum holding ring has openings formed therethrough to permit communication between the first and second compartments and the member extends into the first compartment such that the held piece of chewed gum is disposed in the first compartment, and upon manipulation of the apparatus, the candy pieces in the second compartment travel through the openings and into contact with the chewed gum resulting in the chewed gum being coated with candy pieces that serve to enhance the flavor of the chewed gum as well as adding a crunchy texture thereto.

### TECHNICAL FIELD

The present invention relates generally to a candy referred to as chewing gum and more particularly, relates to an article of manufacture that enhances a chewing gum experience by enhancing the flavor and texture of a piece of chewed gum.

### BACKGROUND

As is known, the candy industry is a large industry with a vast number of products and each participant in this industry is under pressure to maintain or increase market share by either maintaining the popularity of an existing candy line or by introducing a new candy line. One type of popular candy is chewing gum. The history of chewing gum actually dates back to ancient times when the ancient Greeks chewed a substance that was made from the resin of a mastic tree and the ancient Mayans chewed chicle which is the sap from the sapodilla tree. Other people, including the North American Indians and early American settlers chewed substances were made from trees, such as sap from the Spruce tree, and other materials, such as beeswax. While some gums may include some of these materials, such as chicle, the art of manufacturing chewing gum continues to advance over time as companies try to find the right recipes for gums that are fun to chew and have excellent consistency and flavor over time (referred to as long-lasting flavor).

Today's gums are typically made from corn syrup, sugar, and flavoring agents that are later added to a gum base during the gum manufacturing process. Most chewing gums share similar manufacturing techniques up to a certain point where they might then differ slightly in order to produce their own distinct products. More specifically, the gum base is melted in large, steam-jacketed kettles which heat the gum base to elevated temperatures at which point, the gum base achieves the consistency of a thick maple syrup. This substance is then filtered and clarified using conventional equipment while it remains hot and the gum base is introduced into very large mixers that have slowly revolving blades. The other components, beginning with powered sugar, are carefully added to the gum base which is subject to the action of the revolving blades. The other materials, including corn syrup or glucose, softeners, and either natural or artificial flavoring are likewise added the gum base in the large mixing vats, as the large blades slowly turn. The blended gum passes out of the mixers and onto cooling belts and is typically bathed in currents of cool air to reduce the temperature thereof. The gum composition is then delivered to extruders which serve to manipulate the gum and make the texture of the gum much smoother and finer. The gum then passes to other processing equipment, such as giant rollers, which act to flatten the gum into thinner and thinner sheets. From here, the gum is delivered to cutting and scoring machinery which cuts the gum into smaller sheets or is otherwise processed in view of the final configuration of the gum product. Gum can come in a number of different shapes, e.g., it can come in sticks or it can come as gum balls, etc.

Over the years, companies are continuously trying to advance the chewing gum experience by developing bold new flavors and importantly, by developing new recipes that permit the original flavor of the chewing gum to last longer as the user continues to chew the gum. For example, a number of gum manufacturers have developed gum that has extra flavor candy crystals or the like incorporated therein to ensure that the flavor of the gum lasts longer. One particular type of gum that is a favorite with children is bubble gum. As is well known, bubble gum comes in a variety of flavors, including watermelon and grape, and permits the chewer to blow large bubbles.

What has heretofore not been available is a small toy-like accessory that can not only carry and hold several or more pieces of gum but also has a feature that enhances the chewing gum experience by reintroducing flavor to a chewed piece of gum.

### SUMMARY

According to one embodiment, an apparatus for enhancing a chewing gum experience by coating a chewed piece of gum with flavorful crunchy candy bits is provided. The apparatus includes a number of components or parts that releasably interface with one another to form the apparatus. More specifically, the apparatus includes a first container body, a second container body and a gum holding ring. The gum holding ring has a base section and an upstanding member connected thereto by a plurality of radial connecting members. The upstanding member is adapted to receive and hold the chewed piece of gum and can, for example, be a post that extends above an upper edge of the gum holding ring. The gum holding ring has a first annular flange formed as part of a first section and a second annular flange formed as part of a second section.

The first container body is releasably coupled to a first section of the gum holding ring by a friction fit between the first container body and the first flange. The first container body defines a first compartment that receives and holds chewing gum both in its unchewed form and when the piece of gum is chewed and then is placed on the upstanding member. The second container body releasably coupled to a second section of the gum holding ring by a friction fit between the second container body and the second flange. The second container body defines a second compartment for storing the flavorful crunchy candy bits.

The gum holding ring has openings formed therethrough and are defined between adjacent connecting members (e.g., radial spokes) to permit communication between the first and second compartments and the member extends into the first compartment such that the held piece of chewed gum is disposed in the first compartment. Upon manipulation of the apparatus, the flavorful crunchy candy bits in the second compartment travel through the openings and into contact with the chewed gum resulting in the chewed gum being coated with the flavorful crunchy candy bits that serve to enhance the flavor of the chewed gum as well as adding a crunchy texture thereto.

In other words, the apparatus is shaken or otherwise agitated to cause the crunchy candy bits to move through the openings from the second compartment into the first compartment where they stick to the chewed piece of gum that has been disposed (stuck) on the distal end of the upstanding member.

Further aspects and features of the exemplary automated safety cap removal mechanism disclosed herein can be appreciated from the appended Figures and accompanying written description.

### BRIEF DESCRIPTION OF THE DRAWING FIGURES

The foregoing and other features of the present invention will be more readily apparent from the following detailed description and drawing figures of illustrative embodiments of the invention in which:

FIG. 1 is a perspective view of an apparatus for enhancing a chewing gum experience according to one exemplary embodiment;

FIG. 2 is a side elevation view of the apparatus of FIG. 1 with a top body member removed therefrom and a gum holding member being visible;

FIG. 3 is a side elevation view of the apparatus with the top body member removed and a piece of chewed gum is mounted on the gum holding member;

FIG. 4 is a side elevation view of the assembled apparatus with a piece of chewed gum being mounted on the gum holding member;

FIG. 5 is a horizontal cross-sectional view taken through the line 5-5 of FIG. 4;

FIG. 6 is a vertical cross-sectional view taken along the line 6-6 of FIG. 5, with the apparatus being manipulated (shaken);

FIG. 7 is the vertical cross-sectional view of FIG. 6 showing candy bits being adhered to the chewed gum on the gum holding post after conducting a shaking action;

FIG. 8 is a partial cross-sectional view of the gum holding member mated to the top and bottom body members; and

FIG. 9 is a cross-sectional view taken through the line 9-9 of FIG. 8.

### DETAILED DESCRIPTION OF PREFERRED EMBODIMENTS

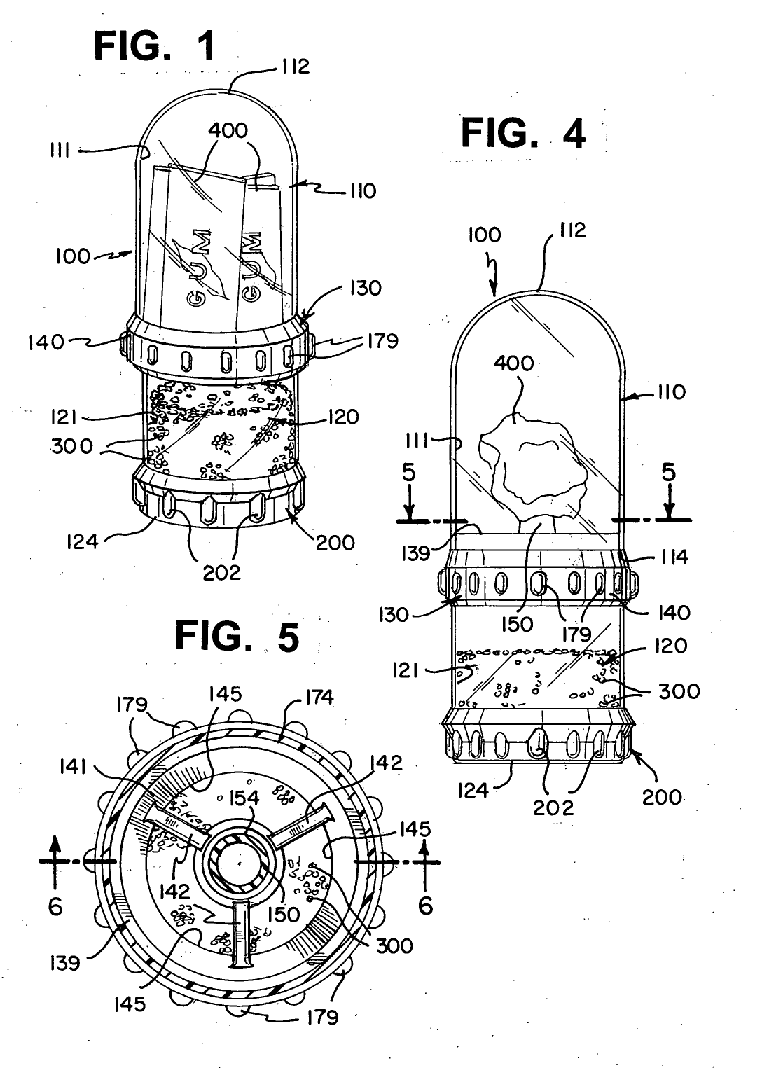

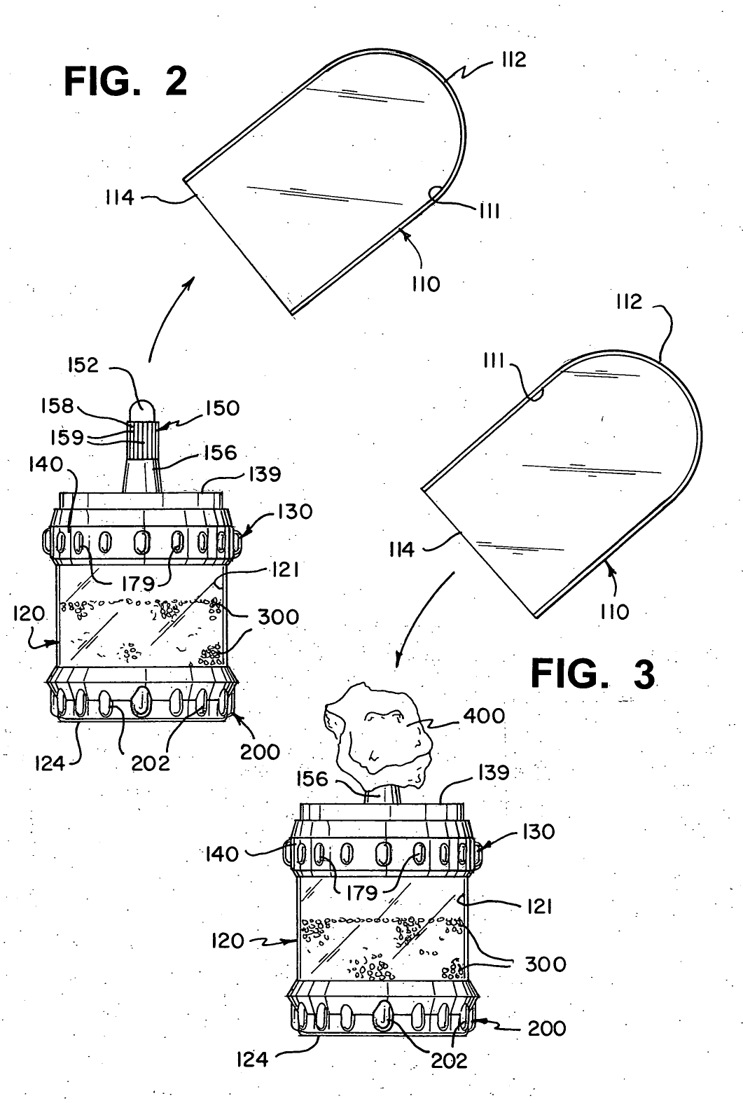

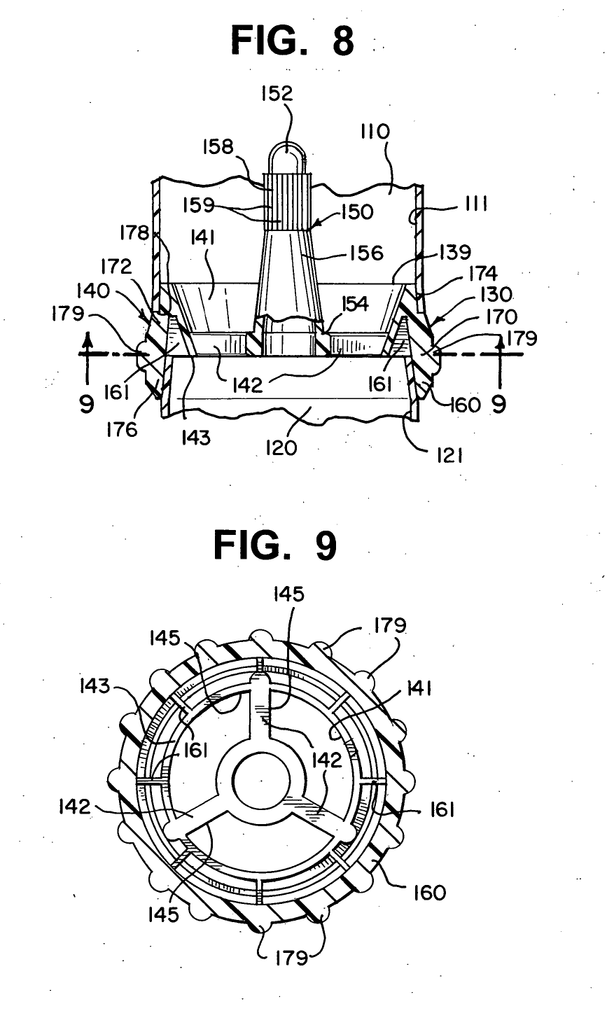

Referring to FIGS. 1-9, FIG. 1 is a perspective view of an apparatus 100 for enhancing a chewing gum experience according to a first embodiment with an optional decorative bottom section 200 being formed as a part thereof. The apparatus 100 is formed of a number of complementary parts or components that interface with one another to form the apparatus 100, which is generally in the form of a container having a holder incorporated therein. More specifically, the apparatus 100 includes an upper body 110, a lower body 120 and a gum holding ring 130 that is complementarily received between and forms an interface between the upper body 110 and the lower body 120 so as to define a container or receptacle that is capable of holding items in two separate compartments, namely a first compartment 111 defined by the upper body 110 and a second compartment 121 defined by the lower body 120. As will be described below, each of the two compartments 111, 121 preferably holds a different candy product and in a preferred embodiment, the candy products in the two compartments 111, 121 complement one another with one of the candy products being a gum product.

The upper body 110 has a closed first end 112 and an open second end 114. The closed first end 112 can have a flat planar top surface or it can be rounded or dome-shaped as shown in the Figures. The upper body 110 is generally an annular shaped member that is at least substantially hollow in nature. The exemplary upper body 110 that is illustrated in the Figures has a shape that is similar to one-half of a rounded pill capsule. An outer surface of the upper body 110 is preferably a smooth surface and this is especially so for the open second end 114 so as to permit this second end 114 to be cleanly received within the gum holding ring 130 as described below. The diameter of the upper body 110 should be of a sufficient size to permit at least two pieces of gum to be easily received and contained therein within the first compartment 111. For example, one suitable gum is individually packaged bubble gum commercially available from the present assignee under the trade name BAZOOKA.

The lower body 120 is preferably similar to the upper body 120 with a few exceptions discussed below. The lower body 120 has an open first end 122 and a closed second end 124. Like the upper body 110, the lower body 120 is a hollow annular-shaped member. Unlike the upper body 110, the closed end (the second end 124) of the lower body 120 is preferably not rounded but rather is a planar end to permit the apparatus 100 to freely stand upright by simply placing the apparatus 100 on its closed second end 124. It is intended that when the apparatus 100 is not in use, one of the preferred storage positions is an upright position.

As is shown in the Figures, the closed end 124 can optionally include the decorative bottom section 200 which not only is for decorative purposes but also has a utilitarian function. More specifically, instead of having a completely smooth outer surface, the bottom body 120 can be contoured and can include a plurality of radially arranged ribs 202 that extend therearound at the second end 124. The bottom body 120 has a slight taper proximate the second end 124 such that the diameter of the bottom section 200 is greater than a diameter of the bottom body 120 at the first end 122. In fact, according to the illustrated embodiment, the bottom section 200 contains two opposite tapers in that there is an innermost first taper (located closer to the first end 122) that tapers outwardly away from the container body and terminates at a point where the taper then reverses and extends back into the container body. In other words, the two tapered surfaces represent two beveled surfaces that comes to a point (an annular ring that extends around the bottom body 120).

The ribs 202 are integrally formed with the inwardly tapered surface and extend down to the second end 124. The ribs 202 are formed such that the distance that the ribs 202 extend away from the bottom body 120 is selected so that the ribs 202 do not extend beyond the intersection between the two beveled surfaces (two tapered surfaces). The ribs 202 serve several purposes, namely, the ribs 202 provide gripping surfaces that assist a user in gripping and holding the apparatus 100 and the ribs 202 also act as an anti-roll means, in combination with similar features formed as part of the gum holding ring 130, in that when and if the apparatus 100 is placed on its side, the ribs 202 (e.g., a pair of adjacent ribs 202) engage the ground and prevent the apparatus 100 from rolling.

The top and bottom bodies 110, 120 have complementary shapes and sizes to one another to permit the two members to engage and interface with one another in such a manner that the two members, along with the gum holding ring 130, at least substantially seal with one another when the two members are securely coupled to one another as the apparatus 100 is assembled and is placed in a closed position.

The top and bottom bodies 110, 120 can be formed of a number of different materials; however, it is preferred that the bodies 110, 120 be formed of a plastic material that is suitable for the intended application. For example, the top and bottom bodies 110, 120 can be in the form of molded plastic members. Preferably, the top and bottom bodies 110, 120 are transparent or at least substantially transparent so that the contents in the first and second compartments 111, 121 can easily be seen by a user. Moreover, the top and bottom bodies 110, 120 can be formed of colored plastics and especially, colored transparent plastics to permit viewing of the first and second compartments 111, 121, while at the same time provides an apparatus with visually pleasing colors. However, it will be understood that the top and bottom bodies 110, 120 can be formed of a clear transparent material or it can be formed of a non-transparent or opaque material or even a semi-transparent material.

The gum holding ring 130 represents a middle or intermediate member of the apparatus 100 and is constructed so that it easily interfaces with each of the top and bottom bodies 110, 120 such that it can be securely coupled to each of these members, while at the same time being releasable therefrom. The gum holding ring 130 includes an annular ring-shaped base 140 and a post or protruding member 150 that is integrally attached to the base 140 and extends upwardly therefrom such that a distal end 152 of the post 150 is located beyond an upper edge 139 of the base 140.

Opposite the distal end 152, the post 150 includes a proximal end 154 which is attached to an inner surface 141 of the base 140. More specifically, the proximal end 154 is attached to the inner wall or surface 141 by means of a plurality of spokes 142 that are integrally formed and extend between the proximal end 154 and the inner surface 141. The spokes 142 are formed radially around the proximal end 154 of the post 150. In the illustrated embodiment, there are three spokes 142 that are uniformly spaced around the post 150. For example, three spokes 142 are arranged about 120 degrees from one another. Between adjacent spokes 142, an opening 145 is formed and thus, in the illustrated embodiment, there are three openings 145 that are defined by the inner wall 141, the spokes 142 and the post 150.

The illustrated post 150 generally has two different sections, namely, a first section 156 that is tapered and is conical in shape and extends from the proximal end 154 to a point where the first section 156 transitions to a second section 158 that has substantially the same diameter from the transition point to the distal end 152. The second section 158 is thus generally a cylindrical member and the distal end 152 is a closed rounded end. Preferably, an outer surface of the second section 158 includes latitudinal ribs or ridges 159 that are formed radially therearound. The ridges 159 extend from a point near but not at the distal end 152 to the transition point. The ridges 159 act as gum gripping and retaining members in that when a user places a piece of chewed gum about the distal end 152 of the post, as described below, the ridges 159 provide a roughened surface as opposed to the surrounding smooth surfaces and this roughened surface assists in gripping and retaining the chewed gum so that it remains disposed about the distal end 152 after the user removes his/her fingers from the gum. For ease of manufacturing (e.g., a molding operation), the post 150 is typically formed as a hollow member.

As best shown on FIGS. 6-8, the inner surface 141 of the base 140 is a surface that slowly slopes or tapers inwardly as one travels down from the top edge 139 of the base 140. The inner surface 141 terminates at a bottom edge 143 where, preferably, the spokes 142 are integrally attached thereto. As best shown in FIG. 9, an underside of the base 140 is defined by a lower section, including the bottom edge 143, of the inner wall 141 which can be thought of as defining an inner annular flange member and an outer annular flange member 160 that is spaced therefrom. The outer annular flange member 160 actually represents a bottom edge of a section 170 of the base 140 that is of increased diameter as explained below. There are a number of radial support features 161 that are formed between and are integrally attached to the inner annular flange and the outer annular flange 160. The features 161 can be in the form of thin support ribs, tabs or fins that are integral to the inner and outer flanges and radially disposed around the inner flange member. The features 161 act as a platform or landing or stop that restricts the degree of travel of the lower body 120 when the two parts are coupled to one another by receiving the lower body 120 between the outer annular flange 160 as described below. It will be appreciated that the bottom edge 143 of the inner flange member, the bottom surface of the post 150, the bottom surfaces of the spokes 142 and the bottom surfaces of the support tabs or fins 161 all lie in substantially the same plane and this forms a recessed platform.

An outer surface 172 of the base 140 is formed of a number of different sections or regions and more specifically, the outer surface 172 includes a first section 174 and a second section 176 with the first section 174 including the top edge 139 and extends down to a ledge or annular landing 178 that defines a transition from the first section 174 to the second section 176. The first section 174 is thus in the shape of annular ring that has an at least substantially constant diameter from one end to the other end thereof. The second section 176 has an increased diameter compared to the first section 174 which explains the formation of the planar ring-shaped landing 178. Similar to the decorative section 200, the second section 176 preferably has a plurality of ribs or ridges 179 formed radially therearound. The ribs 179 have similar shapes as the ribs 202. In other words, the ribs 179 are in the form of oblong-shaped protrusions. In the illustrated embodiment, the ribs 179 are slightly smaller in size compared to the ribs 202 and the spacing theretbetween is slightly less and therefore, the number of ribs 179 is greater than the number of ribs 202.

The assembly and use of the apparatus 100 are now described. During a typical use, the user separates the three components, namely the upper body 110, bottom body 120 and the gum holding ring 130 from each other. A first type of candy 300 is disposed within the second compartment 121 formed in the bottom body 120. Preferably, the first type of candy 300 is of the type that can easily stick to chewed gum and is flavorful so as to provide an enjoyable experience when consumed by the user. For example, one preferred first type of candy 300 is in the form of a large number of small candy nuggets or the like. The nuggets 300 are typically very colorful as well as coming in a number of different flavors. One type of candy 300 that is particularly suited for use in the second compartment 121 is a candy that is commercially available from a number of sources and is in the form of many tiny, tangy, crunchy candy pieces, bits or nuggets that come in a number of different flavors, such as grape, strawberry, watermelon, wild cherry, lemonade, etc.

After the pieces of candy 300 are inserted into the second compartment 121, the gum holding ring 130 is then coupled to the bottom body 120 by inserting the upper edge of the bottom body 120 into the lower portion of the gum holding ring 130 such that the upper edge of the bottom body 120 is disposed between the inner annular flange member and an outer annular flange member 160 and seats against the underside surface of the radially arranged support tabs 161 that extend between the inner and outer flanges. In other words, the radially arranged tabs 161 limit or restrict the degree of travel of the bottom body 120 within the gum holding ring 130.

An outer diameter of the first end 122 of the bottom body 120 is slightly less than an inner diameter of the outer flange 160 of the gum holding ring 130 so to produce a frictional fit between the bottom body 120 and the gum holding ring 130. This frictional coupling between the two parts serves as the means for snuggly yet releasably holding the two parts together. It will be appreciated that when the gum holding ring 130 is coupled to the bottom body 120, the openings 145 are in communication with the second compartment 121 of the bottom body 120 and this permits the candy 300 to be discharged from the second compartment 121. Each individual candy pieces 300 is much smaller than one opening 145 and therefore, a great number of candy pieces 300 can freely travel through the openings 145.

The top body 110 is securely coupled to the gum holding ring 130 by simply manipulating the top body 110 so that the distal end 152 of the post 150 is received within the open second end 114 of the body 110. The inner diameter of the open second end 114 of the top body 110 is slightly greater than the outer diameter of the first section 174 of the outer surface 172 such that a snug friction fit results between the open second end 114 of the top body 110 and the gum holding ring 130. The top body 110 is thus disposed about the first section 174 and is directed downward until the second end 114 of the top body 110 seats against and on the annular landing 178. The annular landing 178 thus acts as a stop or locating feature, similar to how the tabs 161 act for the bottom body 120, that restricts the degree of travel of the top body 110 relative to the gum holding ring 130. When the top body 110 is mated to the gum holding ring 130, the distal end 152 of the post 150 is spaced from the closed first end 112 of the top body 110.

The apparatus 100 acts to increase and enhance a gum chewing experience in the following manner. The top body 110 is designed and constructed to hold one or more and preferably two or more pieces of chewing gum 400 even when the top body 110 is secured to the gum holding ring 130. As shown in FIG. 1, several individually packaged sticks of chewing gum 400 are shown as being contained within the first compartment 111. The gum pieces 400 are arranged around the post 150 and are of sufficient size so that the gum 400 can not fall through the opening 145 into the second compartment 121. The apparatus 100 can be stored in this manner with candy pieces 300 contained in the second compartment 121 and pieces of gum 400 contained in the first compartment 111.

The user then removes the top body 110 from the gum holding ring 130 to permit access to the gum pieces 400 which are sitting within the inner wall 141 on the spokes 142 and against and around the post 150. The user then removes the gum 400 and chews one piece of gum 400. At this time, the user can place any unchewed pieces of gum 400 back on the gum holding ring 130 about the post 150 and then can securely couple the top body 110 back to the gum holding ring 130 in the above described manner.

After the user chews the gum 400 for some time and the gum has lost its flavor, the chewer can then elect to enhance or “boost” the flavor of the gum by using the apparatus 100 instead of discarding the piece of gum 400. To accomplish this, the chewer removes the top body 110 from the gum holding ring 130 and then removes the chewed gum 400 from his or her mouth and places the gum 400 on the distal end 152 of the post 150. More specifically, the chewed gum 400 is stuck to the distal end 152 with the ridges 159 formed as part of the post 150 serving to grip and retain the gum 400 on the post 150.

After the gum 400 is securely attached (stuck) to and about the post 150, the user then places the top body 110 back on the gum holding ring 130 so that the two are again securely coupled to one another. The user then manipulates the apparatus 100 so as to cause the candy 300 to travel from the second compartment 121 into the first compartment 111 into contact with the gum 400. For example, the apparatus 100 can be turned upside down or can be shaken or otherwise manipulated so that the candy 300 freely travels through the openings 145 into the first compartment 111 where the candy 300 encounters the sticky chewed piece of gum 400 resulting in a number of candy pieces 400 sticking (adhering) to the gum 400.

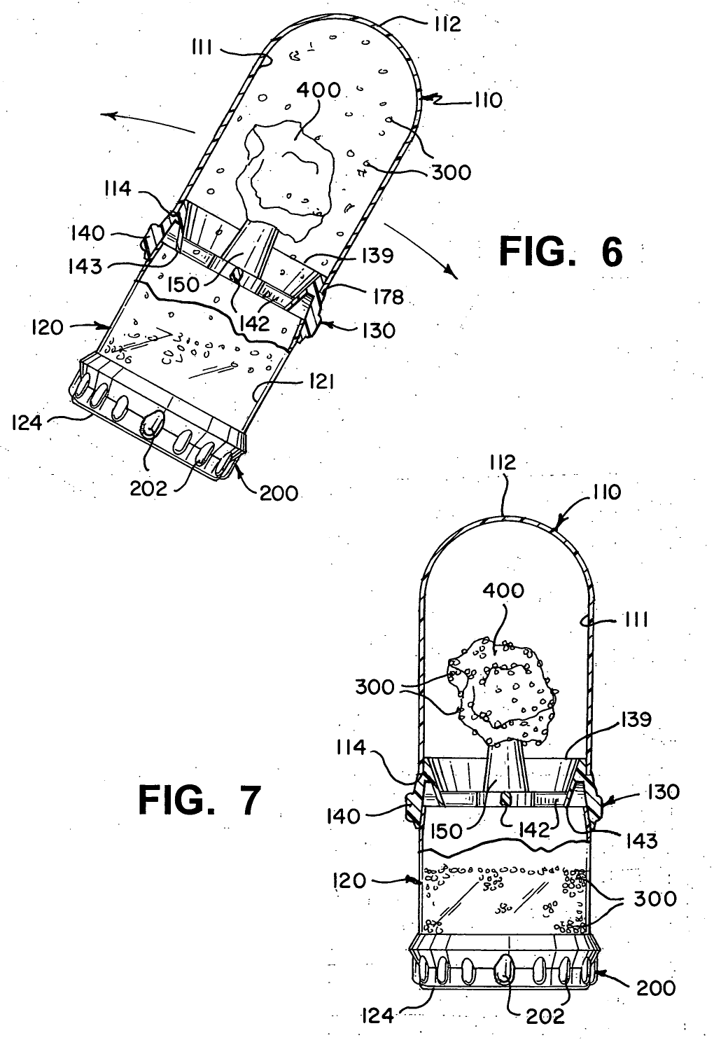

The apparatus 100 is manipulated until the user is pleased with the number of candy pieces 300 that are stuck to the gum 400 and then the user removes the top body 110 to permit access to the candy coated gum 400. The user then removes the candy coated gum 400 from the post 150 and places the piece into his or her mouth and begins chewing again. As previously mentioned, the candy 300 in itself has an associated flavor, e.g., tangy, and also has a texture and therefore, the candy 300, when it is incorporated into the gum 400 (adhering thereto), increases or enhances (“boosts”) or alters the flavor of the chewed gum 400. Moreover, the candy 300 provides the gum 400 with a new texture since the candy 300 is in the form of tiny crunchy candy pieces and therefore, the gum 400 with candy pieces 300 adhered thereto has a crunchy texture as shown in FIG. 7. The candy 300 can also be in the form of a flavored sugar powder which easily sticks to the wet chewed gum.

After performing the candy coating operation, the user can place any unchewed gum 400 back into the first compartment 111 for storage thereof. After chewing the enhanced (“Boosted”) gum, the user can then later in time either discard the chewed piece of gum and chew a new fresh piece of gum or repeat the enhancing operation by applying more candy bits to the chewed gum.

It will be appreciated by persons skilled in the art that the present invention is not limited to the embodiments described thus far with reference to the accompanying drawings; rather the present invention is limited only by the following claims.

1. An apparatus for enhancing a chewing gum experience comprising:
a gum holding ring having an upstanding member for receiving and holding a piece of chewed gum;
a first container body releasably coupled to a first section of the gum holding ring, the first container body defining a first compartment;
a second container body releasably coupled to a second section of the gum holding ring, the second container body defining a second compartment for storing candy, and
wherein the gum holding ring has openings formed therethrough to permit communication between the first and second compartments and the member extends into the first compartment such that the held piece of chewed gum is disposed in the first compartment, and upon manipulation of the apparatus, the candy in the second compartment travels through the openings and into contact with the chewed gum resulting in the chewed gum being coated with the candy that serves to enhance the flavor of the chewed gum.

2. The apparatus of claim 1, wherein the first container body is a substantially hollow member that has a closed first end and an open second end and the second container body is a substantially hollow members that has an open first end and a closed second end.

3. The apparatus of claim 2, wherein each of the first container body and the second container body is a substantially annular member.

4. The apparatus of claim 2, wherein the gum holding ring includes a base section with the upstanding member being selectively attached to the base by a plurality of connecting members, one opening being formed between two adjacent connecting members.

5. The apparatus of claim 4, wherein the upstanding member comprises a post having a distal end and a proximal end that is integrally attached to the connecting members, the post having a surface altering features near the distal end for aiding in gripping and retaining the chewed piece of gum.

6. The apparatus of claim 5, wherein the post has a first cylindrically-shaped section that includes the surface altering features and extends to the distal end and a second conically-shaped section that is formed between the surface altering features and the proximal end.

7. The apparatus of claim 5, wherein the surface altering features are in the form of latitudinal ridges.

8. The apparatus of claim 4, wherein the connecting members comprise a plurality of spokes that are integrally formed with the proximal end of the post and an inner surface of gum holding ring.

9. The apparatus of claim 4, wherein the first section of the base of the gum holding ring includes a first annular flange that along with an annular platform define an annular shoulder, the open second end of the first container body seating against the annular shoulder and on the annular platform.

10. The apparatus of claim 9, wherein the open second end of the first container body is frictionally fit around the first annular flange.

11. The apparatus of claim 8, wherein there are three spokes defining three openings permitting communication between the first and second compartments.

12. The apparatus of claim 1, wherein the first container body is frictionally fit to the first section of the gum holding ring and the second container body is frictionally fit to the second section of the gum holding ring.

13. The apparatus of claim 4, wherein the second section of the base includes an inner flange member and an outer flange member with an annular space being formed therebetween, the open first end of the second container body being disposed between the inner and outer flange members with a frictional fit resulting between the open first end of the second container body and the gum holding ring.

14. The apparatus of claim 13, wherein there are a plurality of connecting members that are integrally formed with and extend between the inner and outer flanges, the connecting members defining an annular ring-shaped platform on which the open first end of the second container body seats against when the second section of the gum holding ring is securely coupled to the open first end of the second container body.

15. The apparatus of claim 14, wherein the plurality of connecting members are in the form of radial spokes or fins that extend radially around the inner flange member.

16. The apparatus of claim 1, wherein an outer surface of the second section of the gum holding ring includes a plurality of ribs formed radially therearound and spaced apart from one another.

17. The apparatus of claim 1, wherein the candy is selected from the group consisting of tiny tangy crunchy candy pieces and candy powder.

18. The apparatus of claim 1, wherein the chewing gum comprises at least two individually packaged pieces of chewing gum that sit on the first section of the gum holding ring against the upstanding member and at least partially across the openings.

19. The apparatus of claim 1, wherein the closed second end of the second container body includes a plurality of vertical ribs integral to and formed around an outer surface of the gum holding ring, the ribs acting as an anti-roll feature when the apparatus is placed on its side since the apparatus sits on a pair of adjacent ribs as opposed to a surrounding smooth surface of the gum retaining ring.

20. The apparatus of claim 1, wherein the closed first end of the first container body has a rounded shape and the closed second end of the second container body is a planar end to permit the apparatus to stand upright thereon.

21. An apparatus for enhancing a chewing gum experience by coating a chewed piece of gum with flavorful crunchy candy bits comprising:
a gum holding ring having a base section and an upstanding member connected thereto by a plurality of radial connecting members, the upstanding member adapted to receive and hold the chewed piece of gum, the gum holding ring having a first annular flange formed as part of a first section and a second annular flange formed as part of a second section;
a first container body releasably coupled to a first section of the gum holding ring by a friction fit between the first container body and the first flange, the first container body defining a first compartment;
a second container body releasably coupled to a second section of the gum holding ring by a friction fit between the second container body and the second flange, the second container body defining a second compartment for storing the flavorful crunchy candy bits, and
wherein the gum holding ring has openings formed therethrough and defined between adjacent connecting members to permit communication between the first and second compartments and the member extends into the first compartment such that the held piece of chewed gum is disposed in the first compartment, and upon manipulation of the apparatus, the flavorful crunchy candy bits in the second compartment travel through the openings and into contact with the chewed gum resulting in the chewed gum being coated with the flavorful crunchy candy bits that serve to enhance the flavor of the chewed gum as well as adding a crunchy texture thereto.
